(19) United States
(12) Patent Application Publication
(10) Pub. No.: US 2023/0418350 A1
(43) Pub. Date: Dec. 28, 2023

(54) PROGRAMMABLE BIASING OF OPERATING FREQUENCIES FOR OPTIMAL POWER SCALING

(71) Applicant: Dell Products L.P., Round Rock, TX (US)

(72) Inventor: Thomas Alexander Shows, Leander, TX (US)

(21) Appl. No.: 17/849,989

(22) Filed: Jun. 27, 2022

(51) Int. Cl. G06F 1/28; G06F 11/34

(52) U.S. Cl. CPC G06F 1/28; G06F 11/3495

(57) ABSTRACT

An information handling system receives a request to switch a processor to a first frequency, and determines a coefficient to be used as a bias against the first frequency. The system also applies the coefficient to the first frequency resulting in a second frequency, and switches the processor to the second frequency.

### FIELD OF THE DISCLOSURE

The present disclosure generally relates to information handling systems, and more particularly relates to programmable biasing of operating frequencies for optimal power scaling.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system receives a request to switch a processor to a first frequency, and determines a coefficient to be used as a bias against the first frequency. The system also applies the coefficient to the first frequency resulting in a second frequency, and switches the processor to the second frequency

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram illustrating an example of a system for programmable biasing of operating frequencies for optimal power scaling, according to an embodiment of the present disclosure;

FIG. 3 is a flowchart illustrating an example of a method for determining operating frequencies for optimal power scaling, according to an embodiment of the present disclosure;

FIG. 4 is a flowchart illustrating an example of a method for programmable biasing of operating frequencies for optimal power scaling, according to an embodiment of the present disclosure;

FIG. 5 is a graph of a performance curve, according to an embodiment of the present disclosure;

FIG. 6 is a graph of a performance curve with performance points determining operating frequencies for optimal power scaling, according to an embodiment of the present disclosure; and

FIG. 7 is a table for programmable biasing of operating frequencies for optimal power scaling, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

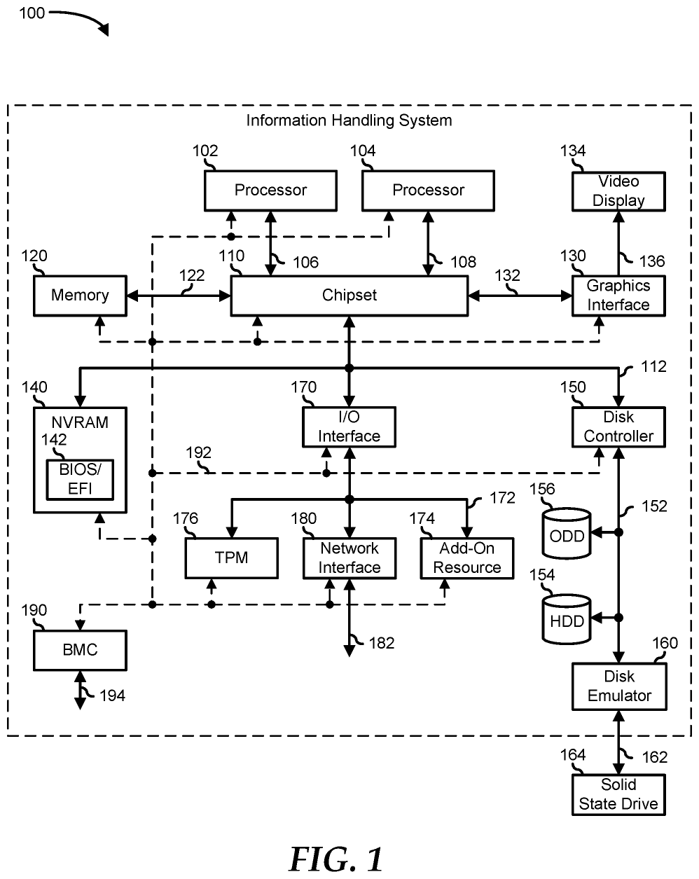

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (×4) PCIe adapter, an eight-lane (×8) PCIe adapter, a 16-lane (×16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on a separate circuit board or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172, and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular-based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out-of-band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device a BMC may be referred to as an embedded controller (EC). A BMC included at a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include an Inter-Integrated Circuit (I2C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor-defined interfaces (such as a Dell EMC Remote Access Controller Administrator (RACADM) utility, a Dell EMC OpenManage Enterprise, a Dell EMC OpenManage Server Administrator (OMSS) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Here, information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I2C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

Because technology and information handling needs and requirements vary between different users and applications, the computing power of processors may range from a few thousand to millions of instructions per second. The variations in the performance of the processors allow the information handling system to be configured for a specific user or usage. For example gaming applications typically demand relatively high computational power, which generally involves the processor operating at increased frequency. Operating at high frequency increases power consumption causing the processor to generate more heat and noise.

The relative performance of the information handling system is measured by benchmarks. A benchmark may provide an analysis of the performance of an information handling system given a specific platform. The benchmark produces a performance score that can be used to compare systems. A higher score indicates better performance. Generally, when the optimal operating frequency biasing function utilizes a “Good/Better/Best” tuning method, there is a large gap between the best performance score and the better performance score. This large gap may be noticeable to a user when the processor switches from one performance level to the other performance level. For example, there may be a noticeable increase in temperature and noise level when the performance level switches from the better to the best performance level. Similarly, there may be a noticeable performance lag when the performance level switches from the best to the better performance level. The inventors have recognized that a better approach would be to have more granular gaps between performance levels. The present disclosure provides programmable bias based on the measured performance of a particular platform and uses this to apply platform-specific coefficients to ensure a more granular variation in the performance of an information handling system.

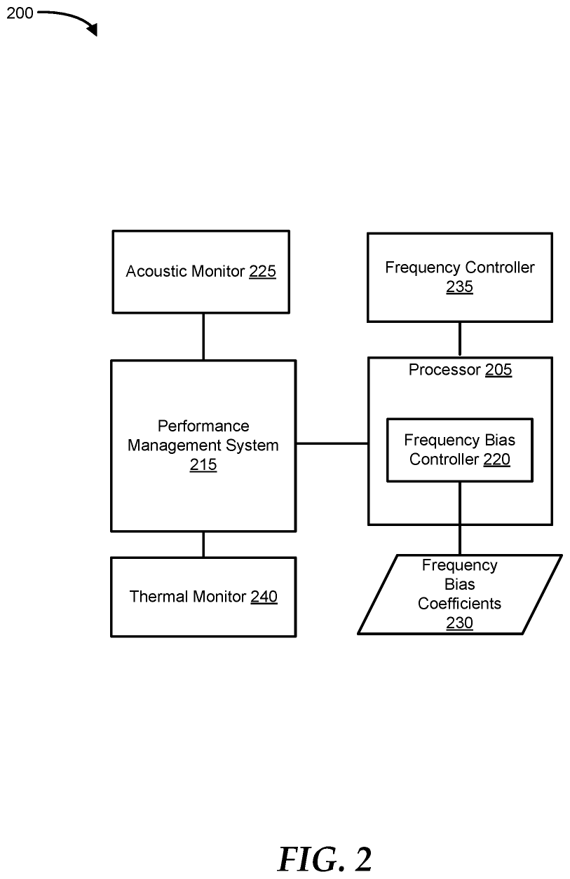

FIG. 2 illustrates an information handling system 200 programmable biasing of operating frequencies for optimal power scaling. Information handling system 200, which is similar to information handling system 100 of FIG. 1, may be configured to dynamically optimize the information handling system for performance, power, thermals, and acoustics. Information handling system 200 includes a processor 205, an operating system 210, a performance management system 215, an acoustic monitor 225, frequency bias coefficients 230, a frequency controller, and a thermal monitor 240. The components of information handling system 200 may be implemented in hardware, software, firmware, or any combination thereof. The components shown are not drawn to scale and information handling system 200 may include additional or fewer components. In addition, connections between components may be omitted for descriptive clarity.

In various embodiments, information handling system 200 may not include each of the components shown in FIG. 2. Additionally, or alternatively, information handling system 200 may include various additional components in addition to those that are shown in FIG. 2. Furthermore, some components that are represented as separate components in FIG. 2 may in certain embodiments instead are integrated with other components. For example, in certain embodiments, all or a portion of the functionality provided by the illustrated components may instead be provided by components integrated into one or more processor(s) as a system-on-a-chip.

Performance management system 215 may be configured to manage the performance of the information handling system at the operating system level or the hardware level, such as part of processor 205. When managing an information handling system, it is desirable to ensure that the information handling system is running efficiently while meeting the performance needs of its workload. In one example, performance management system 215 may use one or more performance states, such as a high performance, balanced performance, and power saver state. During the high-performance state, the processor may be operating at the maximum performance/power configuration, that is at the highest performance with the highest power consumption.

However, operating at a high-performance state comes as a tradeoff because, in addition to power consumption, there are various factors, such as thermal readings, acoustic levels, battery levels, advanced configuration and power interface events, etc. that are taken into account. Accordingly, there are situations wherein it is desirable to scale down the high performance state of the information handling system to a balanced performance state, wherein the processor may be operating at a lesser capacity but the power consumption is also reduced. Similarly, there are further situations wherein the information handling system may be scaled further to the power saver performance state, wherein the processor may be operating at the minimum performance/power configuration to save on power consumption. Similar considerations may be taken into account when scaling up the performance state of the information handling system, such as from the power saver performance state to the balanced performance state. One of skill in the art will appreciate that the performance states used herein are examples, which can be extended to various performance states or levels in practice.

Performance management system 215 may be configured to receive data associated with the various factors, such as from a sensor and/or a monitor. For example, thermal monitor 240 may be configured to provide the thermal conditions to performance management system 215. Similarly, acoustic monitor 225 may be configured to provide acoustic levels to performance management system 215. Performance management system 215 may examine the needs of the workload currently running relative to other factors and determine the desired performance state. The desired performance state may be signaled or transmitted to processor 205 and/or frequency controller 235. Processor 205 may be similar to processor 102 or processor 104 of FIG. 1.

Frequency controller 235 may be configured to vary dynamically the frequency of processor 205 based on a signal or request from performance management system 215, processor 205, frequency bias controller 220. For example, frequency bias controller 220 may be configured to determine a power scaling coefficient, also simply referred to herein as a coefficient, to act as a frequency bias against the frequency associated with the desired performance state determined by performance management system 215, the operating system, and/or processor 205.

The frequency bias controller 220 may adjust the processor frequency associated with the desired performance state using the coefficient, wherein the coefficient may be selected from a set of frequency bias coefficients 230. The frequency bias coefficients 230 may be presented in various formats, such as a frequency bias table, an extensible markup language file, etc. The frequency bias coefficients 230 may include mappings of performance states and corresponding platform-specific coefficients which may be used to determine the coefficient to be applied. For example, if the processor frequency for the high-performance state is 4.2 GHz and the coefficient is 0.85, then the frequency controller may adjust the processor frequency to 3.57 GHz instead.

The platform-specific coefficients may let the processor specify its preference with respect to power-performance tradeoffs present in the processor. Frequency bias coefficients 230 may be programmed into processor 205 and the processor microcode may use them in the internal selection of an operating frequency. In another embodiment, frequency bias coefficients 230 may be stored in a location accessible by frequency bias controller 220, such as a model-specific register, a memory-mapped I/O, etc. The coefficients can be updated based on modalities of use and user preferences to account for conditions characterized during the development of a specific platform while factoring in the platform's own set of constraints.

Those of ordinary skill in the art will appreciate that the configuration, hardware, and/or software components of information handling system 200 depicted in FIG. 2 may vary. For example, the illustrative components within information handling system 200 are not intended to be exhaustive, but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description. In addition, one of ordinary skill in the art will appreciate that these performance states explain typical examples, and the present disclosure is not limited to these three performance states. Performance management system 215 may manage the information handling system through an n-number of performance states.

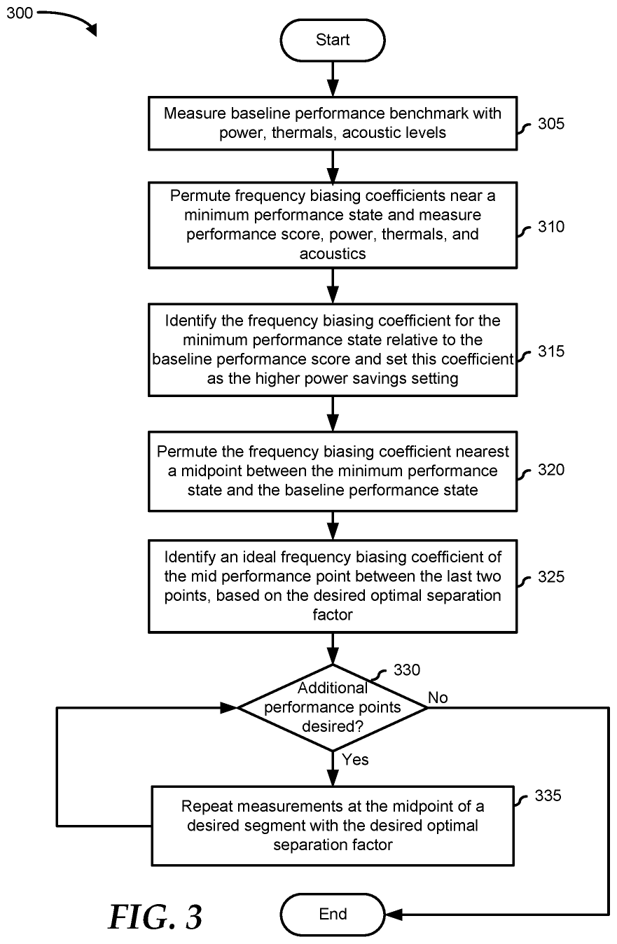

FIG. 3 shows a flowchart of a method 300 for determining frequency biasing coefficients. Method 300 may be performed at the factory for each platform prior to shipping. The resulting set of coefficients may be stored in a location accessible to the CPU of the information handling system. By default, the processor is configured to use the set of coefficients to apply a bias to a desired frequency of the CPU. However, a configuration setting may allow a user or administrator to disable the use of frequency bias. One of skill in the art will appreciate that this flowchart explains a typical example, which can be extended to advanced applications or services in practice.

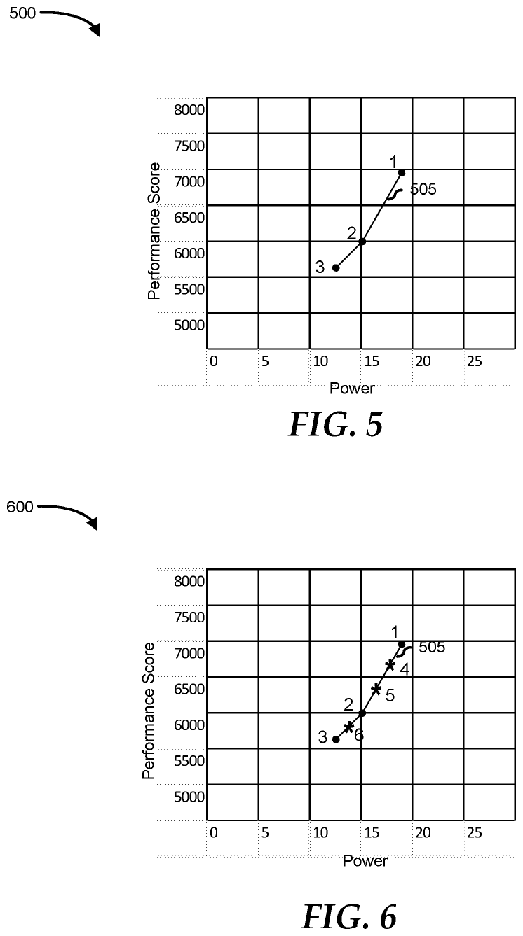

Method 300 typically starts at block 305, where the method establishes a processor's baseline performance/power configuration, also referred simply as the baseline performance state or level. A performance/power configuration may correspond to the performance score of a processor and the power that needs to be supplied to sustain it. A baseline performance point may be marked on a performance curve in a graph similar to FIG. 1. For example, the performance point “1” in graph 500 of FIG. 5 may be used as the baseline performance point.

The baseline performance state may be an optimal performance state wherein the processor can operate over a period of time, which may be pre-determined at the factory, an administrator, or the like. In another embodiment, the baseline performance state may be a maximum performance state. The maximum performance state may be wherein the information handling system is operating at the maximum performance per watt with corresponding maximum acceptable levels of power consumption, thermal conditions, acoustics levels, etc. For example, the maximum performance state may be associated with the highest performance score for that particular platform without overheating with acceptable acoustic levels. The highest performance score may also be associated with the highest processor frequency with the lowest power savings. The baseline performance state is a performance state wherein coefficients associated with other performance states may be based. In one embodiment, the baseline performance state may be the high-performance state referred to above.

At block 310, the method performs a permutation of coefficients within a particular ratio of a minimum performance state. A ratio refers to the distance between two performance points in the curve. A performance point marks the intersection of performance/power configuration in the performance curve. With each permutation, levels of the various factors that may be affected or associated with the processor's performance may be measured, such as the performance score, power consumption, thermal readings, acoustic levels, etc.

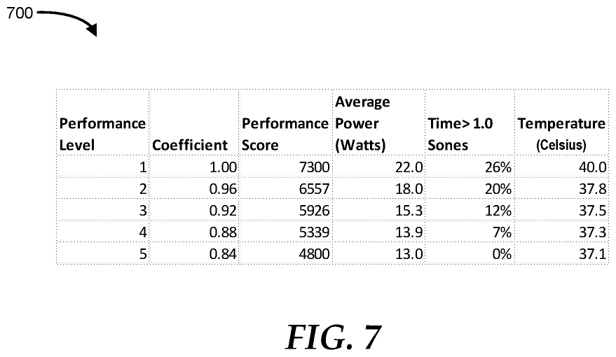

At block 315, the method may identify the frequency biasing coefficient for the minimum acceptable performance state relative to the baseline performance state and set this coefficient in a frequency bias table, similar to FIG. 7. For example, if the coefficient associated with the baseline performance point is one, then the coefficient may have numeric value such that when used to adjust the frequency associated with the baseline performance state results in a frequency associated with the minimum performance state, also referred to as a power saver state above. The minimum performance state may be represented as a performance point “3” in graph 500 of FIG. 5.

The minimum performance state may be wherein the information handling system is operating at the minimum performance per watt and with corresponding minimum acceptable levels of power consumption, thermal conditions, acoustics levels, etc. For example, the minimum performance point may be associated with the lowest performance score for that particular platform that is acceptable to a user without visible user issues. The lowest performance score may also be associated with the lowest processor frequency with the highest power savings. In another embodiment, the minimum performance state may be determined based on the permutations and pre-determined acceptable levels of the various factors mentioned above. In another embodiment, the minimum performance state may be statistically determined based on the permutations. For example, the minimum performance state may be the mean, the median, or the lowest performance state among the permutations with acceptable levels of the aforementioned factors.

At block 320, the method may permute the frequency biasing coefficients nearest a midpoint between the baseline point between the baseline performance point and the minimum performance point. A mid-performance point may be represented as performance point “2” in graph 500 of FIG. 5. The mid-performance point may be associated with the balanced performance state, wherein the performance/power configuration is between the baseline performance/power configuration and the minimum performance/power configuration.

The mid-performance state may be based on the desired optimal separation factor between levels of factors associated with the mid-performance point, such as thermals, acoustics, power, or performance. For example, a midpoint performance score may be an optimal desired mid-performance score. In another embodiment, the midpoint performance point may be a numerical midpoint between the maximum performance point and the minimum performance point, such that the midpoint performance point has an equidistant interval between the baseline performance point and the minimum performance point.

At block 325, the method may identify a frequency biasing coefficient for the mid-performance point, based on the desired optimal separation factor between levels of factors associated with the performance point, such as thermals, acoustics, power, or performance. For example, the desired separation factor for temperature levels between a temperature at the maximum performance point and the temperature at the mid-performance point is 2.5 degrees Celsius. Similarly, the desired separation factor for temperature levels may be between the temperature at the minimum performance point and the temperature at the mid-performance point is 2.5 degrees Celsius. Separation points for the other factors may also be determined.

At decision block 330, the method determines if there are additional performance points desired to optimize the performance states. For example, a configuration setting may provide the number of performance points to be determined for the performance curve. In another example, the configuration setting may provide the desired ratio or intervals between two performance points. If there are additional performance points for optimization, then the method the “YES” branch is taken, and the method proceeds to block 335. If there are no additional performance points desired, then the “NO” branch is taken and the method ends.

At block 335, the method may repeat measurements at the midpoint of the desired segment between two performance points. The repeat measurements may be based on the desired optimal separation factor, such as thermals, acoustics, power, performance levels, etc. For example, the segment selected may be between performance points 1 and 2 of graph 500 of FIG. 5. A midpoint in the segment may be selected based on the desired separation factors. The midpoint may be equidistant from performance point 2 and performance point 1. The midpoint may be associated with a mid-performance point relative to performance points 2 and 1. The method may permute frequency biasing coefficients near the mid-performance point and determine a biasing coefficient that is nearest the midpoint. This block may be performed recursively until a desired ratio or interval between the performance points is achieved and the method ends.

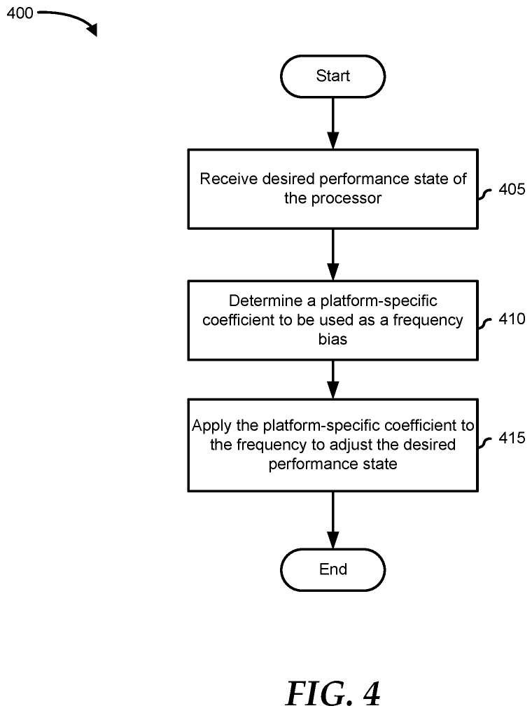

FIG. 4 shows a flowchart of method 400 for programmable biasing of operating frequencies for optimal power scaling. Method 400 may be performed by processor 205 and/or frequency bias controller 220 of FIG. 2. Processor 205 includes frequency bias controller 220 to apply a bias which constrains the operating frequency of the processor core(s). This enables the operating system/processor to scale the processor frequency up or down to save power or improve performance. However, while embodiments of the present disclosure are described in terms of information handling system 200 of FIG. 2, it should be recognized that other systems may be utilized to perform the described method. One of skill in the art will appreciate that this flowchart explains a typical example, which can be extended to advanced applications or services in practice.

Method 400 typically starts at block 405 where a performance management system, operating system, or processor selects a performance state or frequency based on the current workload. The performance management system may be a microcode in the processor or a firmware/software in the operating system. Based on the selected frequency, other desired levels or settings may be selected for various factors, such as thermals, acoustics, power, etc. The performance management system may determine a performance state based on the desired frequency and levels of the various said factors.

At block 410, the method determines a coefficient that may be used to act as a bias for the frequency in block 405. The method may determine the coefficient according to a set of rules or policies. The coefficient may be retrieved from a frequency bias table, such as shown in FIG. 7. The coefficient may be based on the desired frequency and its mapping to a performance point. For example, if the desired frequency is associated with performance level two based on the frequency bias table 700 of FIG. 7 and the current performance level is at one, then the method may select a frequency bias for performance level four. Performance level four is depicted as the next performance point as shown in graph 600 of FIG. 6.

This would allow the method to make more gradual or incremental up/down adjustments to the processor's performance. For example, instead of adjusting the frequency to performance point two (which has around six thousand marks for its performance score at fifteen watts, from performance point one (which has around seven thousand marks for its performance score at eighteen watts) with a difference of approximately one thousand marks, the method may apply the frequency coefficient and drop the frequency of the processor to six thousand six hundred marks, at performance point four. This switch would provide a drop of four hundred performance marks instead of one thousand marks. At block 415, the method applies the coefficient to the processor frequency to adjust the desired performance state.

FIG. 5 shows a graph 500 with a performance curve 505 that illustrates the relationship between performance scores and power consumed in watts of a particular platform. Depicted in the graph are three different performance points marked as one, two, and three. The performance point one is associated with a high-performance state, performance point two is associated with the balanced performance state, and performance point three is associated with the power saver performance state. In this example, there is approximately 24% drop from seven thousand marks to six thousand marks from performance point one to performance point two.

FIG. 6 shows a graph 600 with a performance curve 505 that illustrates the relationship between performance scores and power consumed in watts of a particular platform with additional performance points for optimization. As depicted in the graph, performance points four, five, and six have been added to the performance curve. The performance points are associated with a coefficient to act as a frequency bias when the scaling power or performance of the processor. For example, instead of scaling down the performance of the processor to performance point two from performance point one, by applying the coefficient associated with performance point four, the performance of the processor would be scaled down to performance point four, which is a more gradual drop. In this example, there is approximately 10% drop from seven thousand marks to six thousand six hundred marks from performance point one to performance point four, which is a more gradual drop. Similarly, the performance of the processor may be scaled up or down incrementally. For example, the performance of the processor may be scaled from performance point two to performance point five instead of to performance point one.

FIG. 7 shows frequency bias table 700 which shows performance levels associated with coefficients that may be used to act as a frequency bias. Frequency Bias table 700 includes performance states or levels that are depicted as performance points in FIG. 6. Each performance level is associated with a coefficient which may have been based on determinations by method 300 of FIG. 3. The platform-specific set of coefficients may be used as a bias to gradually scale down/up the power and/or performance of a processor. This allows the performance level to have more granular adjustments. Also shown in frequency bias table 700 are levels of various factors associated with each performance level.

Although FIG. 3, and FIG. 4 show example blocks of method 300 and method 400 in some implementations, method 300 and method 400 may include additional blocks, fewer blocks, different blocks, or differently arranged blocks than those depicted in FIG. 3 and FIG. 4. Those skilled in the art will understand that the principles presented herein may be implemented in any suitably arranged processing system. Additionally, or alternatively, two or more of the blocks of method 300 and method 400 may be performed in parallel. For example, block 305 and block 310 of method 300 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein. In addition, although the present disclosure uses a processor as an example, the system and method herein may apply to other devices, wherein a gradual control of frequency and/or power is desired. For example, the present disclosure may be used to adjust the performance of a fan or gear shifting in a car.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that causes a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
receiving, by a processor, a request to switch the processor to a first frequency;
determining a coefficient to be used as a bias against the first frequency;
applying the coefficient to the first frequency resulting in a second frequency; and
switching the processor to the second frequency.

2. The method of claim 1, wherein the first frequency is selected by a performance management service.

3. The method of claim 2, wherein the first frequency is selected by the performance management service based on a workload of the processor.

4. The method of claim 1, wherein the coefficient is used to incrementally adjust the first frequency.

5. The method of claim 1, wherein the coefficient is determined from a set of coefficients.

6. The method of claim 5, wherein the set of coefficients is based on a plurality of performance scores relative to a baseline performance score.

7. The method of claim 6, wherein determining the performance scores includes:
determining the baseline performance score;
determining a minimum performance score of the processor;
determining the performance scores between the baseline performance score and the minimum performance score, wherein each of the performance scores is at a midpoint between two of the performance scores; and
determining a particular coefficient for each performance score, wherein the particular coefficient is relative to the baseline performance score.

8. The method of claim 7, wherein the minimum performance score is based on a permutation of of performance scores.

9. An information handling system, comprising:
a processor; and
a memory device storing code that when executed causes the processor to perform operations, the operations including:
receiving a request to switch the processor to a first frequency;
determining a coefficient to be used as a bias against the first frequency;
applying the coefficient to the first frequency resulting in a second frequency; and
switching the processor to the second frequency.

10. The information handling system of claim 9, wherein the first frequency is selected by a performance management service.

11. The information handling system of claim 9, wherein the coefficient is determined from a set of coefficients.

12. The information handling system of claim 11, wherein the set of coefficients is based on a plurality of performance scores relative to a baseline performance score.

13. The information handling system of claim 12, wherein determining the performance scores includes:
determining the baseline performance score;
determining a minimum performance score of the processor;
determining the performance scores between the baseline performance score and the minimum performance score, wherein each of the performance scores is at a midpoint between two of the performance scores; and
determining a particular coefficient for each performance score, wherein the particular coefficient is relative to the baseline performance score.

14. The information handling system of claim 13, wherein the minimum performance score is based on a permutation of performance scores near the minimum performance score.

15. A non-transitory computer readable medium including store instructions that are executable to perform operations comprising:
receiving a request to switch a processor to a first frequency;
determining a coefficient to be used as a bias against the first frequency;
applying the coefficient to the first frequency resulting in a second frequency; and
switching the processor to the second frequency.

16. The non-transitory computer readable medium of claim 15, wherein the first frequency is selected by a performance management service.

17. The non-transitory computer readable medium of claim 16, wherein the first frequency is selected by the performance management service based on a workload of the processor.

18. The non-transitory computer readable medium of claim 15, wherein the coefficient is used to incrementally adjust the first frequency.

19. The non-transitory computer readable medium of claim 15, wherein the coefficient is determined from a set of coefficients.

20. The non-transitory computer readable medium of claim 19, wherein the set of coefficients is based on a plurality of performance scores relative to a baseline performance score.
